(19) United States
(12) Patent Application Publication
(10) Pub. No.: US 2025/0286223 A1
(43) Pub. Date: Sep. 11, 2025

(54) SECONDARY BATTERY AND ELECTRONIC DEVICE

(71) Applicant: Ningde Amperex Technology Limited, Ningde (CN)

(72) Inventor: Meina YAO, Ningde (CN)

(73) Assignee: Ningde Amperex Technology Limited, Ningde (CN)

(21) Appl. No.: 19/074,538

(22) Filed: Mar. 10, 2025

(30) Foreign Application Priority Data
Mar. 11, 2024 (CN) 202410276100.0

(51) Int. Cl. H01M 50/46; H01M 4/02; H01M 4/133; H01M 4/62; H01M 10/0525; H01M 10/0587; H01M 50/414; H01M 50/426; H01M 50/434; H01M 50/443; H01M 50/446; H01M 50/449

(52) U.S. Cl. CPC H01M 50/461; H01M 4/133; H01M 4/622; H01M 10/0525; H01M 10/0587; H01M 50/414; H01M 50/426; H01M 50/434; H01M 50/443; H01M 50/446; H01M 50/449; H01M 2004/021; H01M 2004/027

(57) ABSTRACT

An secondary battery includes an electrode assembly. The electrode assembly is a jelly-roll structure. The electrode assembly includes a positive electrode plate, a negative electrode plate, a first separator, and a second separator. The negative electrode plate is located between the first separator and the second separator. The first separator includes a first bonding layer. The second separator includes a second bonding layer. The first bonding layer includes a first binder. The second bonding layer includes a second binder. The first binder includes at least one of polyvinylidene fluoride or poly(vinylidene fluoride-co-hexafluoropropylene). The second binder includes at least one of polyimide, polyvinyl alcohol, or sodium carboxymethyl cellulose.

### CROSS-REFERENCE TO RELATED APPLICATION

This application claims priority to Chinese Patent Application No. 202410276100.0, filed on Mar. 11, 2024, the entire content of which is incorporated herein by reference.

### TECHNICAL FIELD

This application relates to the field of electrochemical technology, and in particular, to a secondary battery and an electronic device.

### BACKGROUND

The structure and properties of a separator in a lithium-ion battery directly affect the capacity, cycle performance, and safety performance of the lithium-ion battery. Currently, the separator currently widely used in a lithium-ion battery is a polyolefinic microporous film such as polyethylene (PE) microporous film or polypropylene (PP) microporous film. The polyolefinic microporous film exhibits excellent chemical stability and mechanical properties. However, the melting point of the polyolefin is relatively low, and the preparation process of the polyolefin includes a stretching process. The polyolefin is prone to shrink and melt at high temperature to cause a short circuit between a positive electrode plate and a negative electrode plate, thereby giving rise to safety hazards. In addition, a nonpolar polyolefinic microporous film can hardly be infiltrated by an electrolyte solution. Some of the micropores in the separator are unable to be filled with the electrolyte solution, resulting in an increase in the impedance of the separator, and impairing the cycle performance and C-rate performance of the lithium-ion battery.

Researchers have developed a method to improve the thermal stability and electrochemical performance of the separator by applying an bonding layer onto a surface of the polyolefinic microporous film. The binders polyvinylidene fluoride (PVDF) and poly(vinylidene fluoride-co-hexafluoropropylene) (PVDF-HFP) are well compatible with the electrolyte solution and are of high adhesiveness to an electrode plate. However, the melting point of such binders is as low as 115° C. to 170° C. The binders melt at relatively high temperature, resulting in failure to effectively adhere to active material particles on the electrode plate. Polyimide (PI), polyvinyl alcohol (PVA), and sodium carboxymethyl cellulose (CMC-Na) melt at a relatively high melting point that is higher than 200° C., and can improve the thermal stability of the separator at high temperature, but are unable to swell effectively and unable to effectively improve adhesiveness and ionic conductivity, thereby deteriorating the electrochemical performance of the lithium-ion battery.

### SUMMARY

An objective of this application is to provide a secondary battery and an electronic device to reduce the expansion rate of the secondary battery and improve the cycle performance, C-rate performance, and safety performance of the secondary battery. Specific technical solutions are as follows:

A first aspect of this application provides a secondary battery. The secondary battery includes an electrode assembly. The electrode assembly is a jelly-roll structure. The electrode assembly includes a positive electrode plate, a negative electrode plate, a first separator, and a second separator. The negative electrode plate is located between the first separator and the second separator. The first separator includes a first bonding layer. The second separator includes a second bonding layer. The first bonding layer includes a first binder. The second bonding layer includes a second binder. The first binder includes at least one of polyvinylidene fluoride or poly(vinylidene fluoride-co-hexafluoropropylene). The second binder includes at least one of polyimide, polyvinyl alcohol, or sodium carboxymethyl cellulose. In the secondary battery of this application, the first separator and the second separator of different types are used in combination, thereby reducing an expansion rate of the secondary battery, and improving the cycle performance, C-rate performance, and safety performance of the secondary battery.

In an embodiment of this application, the negative electrode plate includes a negative current collector as well as a first negative electrode material layer and a second negative electrode material layer located on two sides of the negative current collector respectively. Along a winding direction of the electrode assembly, a length of the first negative electrode material layer is greater than a length of the second negative electrode material layer. The first separator is located on a same side as the first negative electrode material layer of the negative electrode plate. The second separator is located on a same side as the second negative electrode material layer of the negative electrode plate. In this way, the swelling capacity of the first binder in the electrolyte solution is relatively large, thereby making it convenient for the first separator to store more electrolyte solution. When the first separator is located on the same side as the first negative electrode material layer of the negative electrode plate, it is convenient to adsorb more electrolyte solution on the A side of the negative electrode plate of the secondary battery, thereby reducing the risk of lithium plating at the interface between the electrolyte solution and the negative electrode plate caused by electrolyte flow discontinuity at the later stage of cycling of the secondary battery. In addition, the above structure disposed in the secondary battery can reduce the expansion rate of the secondary battery and improve the cycle performance and C-rate performance of the secondary battery.

In an embodiment of this application, the coating weight of the first bonding layer is 0.0004 mg/mm² to 0.002 mg/mm², and the coating weight of the second bonding layer is 0.0004 mg/mm² to 0.002 mg/mm². By controlling the coating weight of the first bonding layer and the coating weight of the second bonding layer within the ranges specified herein, this application achieves relatively high adhesion between the first separator and the positive electrode plate and/or between the first separator and the negative electrode plate, and between the second separator and the positive electrode plate and/or between the second separator and the negative electrode plate, and strengthens the interface between the first separator and the positive electrode plate and/or the interface between the first separator and the negative electrode plate, and the interface between the second separator and the positive electrode plate and/or the interface between the second separator and the negative electrode plate. This facilitates transmission of lithium ions, and further improves the cycle performance, C-rate performance, and safety performance of the secondary battery.

In an embodiment of this application, an average particle diameter of the first binder is 4 μm to 15 μm, and an average particle diameter of the second binder is 10 μm to 20 μm. By controlling the average particle diameter of the first binder and the average particle diameter of the second binder within the ranges specified herein, this application achieves suitable average particle diameters of the first binder and the second binder. In this way, the first bonding layer slurry for preparing the first bonding layer is of a suitable viscosity, and the second bonding layer slurry for preparing the second bonding layer is of a suitable viscosity. Therefore, the first bonding layer and the second bonding layer are of relatively high adhesion, and can strengthen the interface between the first separator and the positive electrode plate and/or the interface between the first separator and the negative electrode plate, and the interface between the second separator and the positive electrode plate and/or the interface between the second separator and the negative electrode plate, thereby facilitating transmission of lithium ions and further improving the cycle performance and C-rate performance of the secondary battery.

In an embodiment of this application, the first negative electrode material layer includes a third binder. The third binder includes at least one of polyvinylidene fluoride, carboxymethyl cellulose, polyacrylic acid, polyvinyl alcohol, or sodium alginate. An average particle diameter of the third binder is 130 nm to 150 nm. By controlling the first negative electrode material layer to include the third binder and controlling the type and average particle diameter of the third binder to fall within the ranges specified herein, the third binder matches the first binder, and the negative electrode plate can be more firmly adhered to the first separator, thereby further improving the cycle performance and safety performance of the secondary battery.

In an embodiment of this application, the second negative electrode material layer includes a fourth binder. The fourth binder includes at least one of polyvinylidene fluoride, carboxymethyl cellulose, polyacrylic acid, polyvinyl alcohol, or sodium alginate. An average particle diameter of the fourth binder is 130 nm to 150 nm. By controlling the second negative electrode material layer to include the fourth binder and controlling the type and average particle diameter of the fourth binder to fall within the ranges specified herein, the fourth binder matches the second binder, and the negative electrode plate can be more firmly adhered to the second separator, thereby further improving the cycle performance and safety performance of the secondary battery.

In an embodiment of this application, the first negative electrode material layer includes a first negative active material. An average particle diameter of the first negative active material is 11 μm to 24 μm. The first negative electrode material layer includes a first negative active material. By controlling the average particle diameter of the first negative active material within the range specified herein, the first negative active material possesses a suitable average particle diameter, and a suitable contact area exists between the first negative active material and the first binder in the first separator. In this way, the first separator is of relatively high adhesion to the negative electrode plate, thereby facilitating transmission of lithium ions, further improving the cycle performance and C-rate performance of the secondary battery, and also contributing to a relatively low expansion rate of the secondary battery.

In an embodiment of this application, the second negative electrode material layer includes a second negative active material. An average particle diameter of the second negative active material is 11 μm to 24 μm. The second negative electrode material layer includes a second negative active material. By controlling the average particle diameter of the second negative active material within the range specified herein, the second negative active material possesses a suitable average particle diameter, and a suitable contact area exists between the second negative active material and the second binder in the second separator. In this way, the second separator is of relatively high adhesion to the negative electrode plate, thereby facilitating transmission of lithium ions, further improving the cycle performance and C-rate performance of the secondary battery, and also contributing to a relatively low expansion rate of the secondary battery.

In an embodiment of this application, the first separator further includes a first ceramic coating, and/or, the second separator further includes a second ceramic coating. The first ceramic coating includes a first ceramic particle. The second ceramic coating includes a second ceramic particle. The first ceramic particle and the second ceramic particle each are at least one independently selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide. The first separator further includes a first ceramic coating and/or the second separator further includes a second ceramic coating, and the type of the first ceramic particles in the first ceramic coating and the type of the second ceramic particles in the second ceramic coating fall within the ranges specified herein, thereby further improving the thermal stability and mechanical strength of the first separator and the second separator, effectively alleviating the shrinkage of the first separator and the second separator at high temperature, and in turn, further improving the safety performance of the secondary battery.

A second aspect of this application provides an electronic device. The electronic device includes the secondary battery disclosed in any one of the preceding embodiments. Therefore, the electronic device provided in this application exhibits good operating performance.

Some of the beneficial effects of this application are as follows:

This application provides a secondary battery and an electronic device. The secondary battery includes an electrode assembly. The electrode assembly is a jelly-roll structure. The electrode assembly includes a positive electrode plate, a negative electrode plate, a first separator, and a second separator. The negative electrode plate is located between the first separator and the second separator. The first separator includes a first bonding layer. The second separator includes a second bonding layer. The first bonding layer includes a first binder. The second bonding layer includes a second binder. The first binder includes at least one of polyvinylidene fluoride or poly(vinylidene fluoride-co-hexafluoropropylene). The second binder includes at least one of polyimide, polyvinyl alcohol, or sodium carboxymethyl cellulose. In the secondary battery of this application, the first separator and the second separator of different types are used in combination, thereby reducing an expansion rate of the secondary battery, and improving the cycle performance, C-rate performance, and safety performance of the secondary battery.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a schematic structural diagram of an electrode assembly according to an embodiment of this application;

FIG. 2 is a schematic structural diagram of an electrode assembly according to another embodiment of this application;

FIG. 3 is a schematic structural diagram of an electrode assembly according to still another embodiment of this application;

FIG. 4 is a schematic structural diagram of an electrode assembly according to still another embodiment of this application; and

FIG. 5 is a schematic structural diagram of an electrode assembly according to still another embodiment of this application.

### LIST OF REFERENCE NUMERALS

electrode assembly 100; first separator 10; first base film 11; first bonding layer 12; first ceramic coating 13; second separator 20; second base film 21; second bonding layer 22; second ceramic coating 23; negative electrode plate 30; negative current collector 31; negative electrode material layer 32; first negative electrode material layer 33; second negative electrode material layer 34; positive electrode plate 40; positive current collector 41; positive electrode material layer 42.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in specific embodiments of this application, this application is construed by using a lithium-ion battery as an example of the secondary battery, but the secondary battery of this application is not limited to the lithium-ion battery.

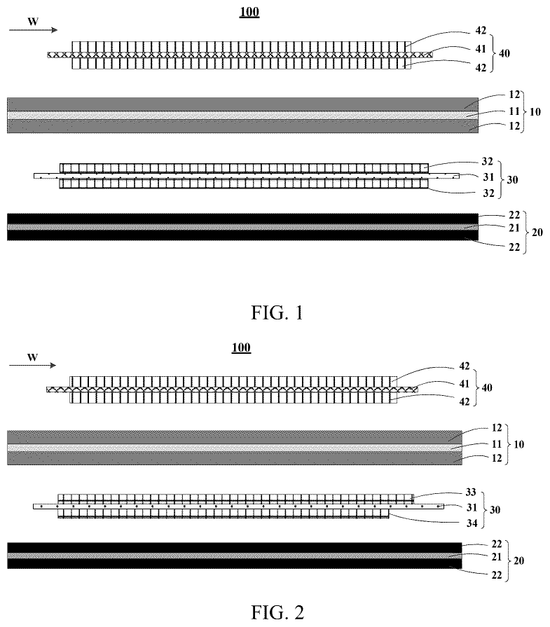

This application provides a secondary battery. The secondary battery includes an electrode assembly. The electrode assembly is a jelly-roll structure. The winding direction of the electrode assembly is defined as a W direction. The electrode assembly includes a positive electrode plate, a negative electrode plate, a first separator, and a second separator. A person skilled in the art understands that the winding direction of the positive electrode plate, the negative electrode plate, the first separator, and the second separator is the same as the winding direction of the electrode assembly. To facilitate understanding of the positional relationship between the positive electrode plate, the negative electrode plate, the first separator, and the second separator in the electrode assembly, FIG. 1 shows a schematic diagram of a partial structure of the electrode assembly unwound along the winding direction W. As shown in FIG. 1, the electrode assembly 100 includes a first separator 10, a second separator 20, a negative electrode plate 30, and a positive electrode plate 40. The negative electrode plate 30 is located between the first separator 10 and the second separator 20. The first separator includes a first bonding layer 12. The first separator 10 further includes a first base film 11. The first bonding layer 12 is disposed on both sides of the first base film 11. The second separator 20 includes a second bonding layer 22. The second separator 20 further includes a second base film 21. The second bonding layer 22 is disposed on both sides of the second base film 21. The negative electrode plate 30 includes a negative current collector 31 and a negative electrode material layer 32 disposed on both surfaces of the negative current collector 31. The positive electrode plate 40 includes a positive current collector 41 and a positive electrode material layer 42 disposed on both surfaces of the positive current collector 41.

The first bonding layer includes a first binder, and the second bonding layer includes a second binder. The first binder includes at least one of polyvinylidene fluoride or poly(vinylidene fluoride-co-hexafluoropropylene). The second binder includes at least one of polyimide, polyvinyl alcohol, or sodium carboxymethyl cellulose.

Currently, the base film of a separator is typically made of a polyolefinic microporous film. The polyolefinic microporous film exhibits excellent chemical stability and mechanical properties. However, the melting point of the polyolefin is relatively low, and the preparation process of the polyolefin includes a stretching process. The polyolefin is prone to shrink and melt at high temperature to cause a short circuit between a positive electrode plate and a negative electrode plate, thereby giving rise to safety hazards. In addition, a nonpolar polyolefinic microporous film can hardly be infiltrated by an electrolyte solution. Some of the micropores in the separator are unable to be filled with the electrolyte solution, resulting in an increase in the impedance of the separator, and impairing the cycle performance and C-rate performance of the lithium-ion battery. The thermal stability and electrochemical performance of the separator can be improved by applying an bonding layer onto a surface of the polyolefinic microporous film. The binder in the bonding layer in the separator includes polyvinylidene fluoride (PVDF), poly(vinylidene fluoride-co-hexafluoropropylene) (PVDF-HFP), polyimide (PI), polyvinyl alcohol (PVA), or sodium carboxymethyl cellulose (CMC-Na). The PVDF and PVDF-HFP exhibit the advantages such as low crystallinity and glass transition temperature, high compatibility with an electrolyte solution, and high adhesiveness to an electrode plate. However, the PVDF and PVDF-HFP melt at a melting point as low as 115° C. to 170° C. When an external temperature is close to the melting point of the binder, the binder melts and is unable to effectively adhere to the positive electrode plate or negative electrode plate, thereby failing to further prevent shrinkage of the base film of the separator. The PI, PVA, and CMC-Na melt at a relatively high melting point that is higher than 200° C., and can effectively adhere to the positive electrode plate or the negative electrode plate at higher temperature, and can improve the thermal stability of the separator at high temperature. However, such binders are unable to swell effectively in the electrolyte solution, and unable to effectively improve adhesiveness and ionic conductivity, thereby deteriorating the electrochemical performance of the secondary battery. In this application, “high temperature” means a temperature higher than 180° C.

The applicant hereof finds through research that the advantages of different materials of the separators can be exerted effectively when the first separator is prepared by using the above type of first binder, the second separator is prepared by using the above type of second binder, and the first separator and the second separator are used together. The first separator is of relatively high ionic conductivity and relatively high electrochemical stability, and is well compatible with different negative active materials, thereby facilitating transmission of lithium ions during charge and discharge, and improving the cycle performance and C-rate performance of the secondary battery. The second separator is of relatively high thermal stability. The second separator is not easily shrinkable at high temperature, thereby improving the safety performance of the secondary battery. In addition, the first separator and second separator of different types used together can achieve relatively high adhesion between the first separator and the positive electrode plate and/or between the first separator and the negative electrode plate, and between the second separator and the positive electrode plate and/or between the second separator and the negative electrode plate, and implement close contact between the first separator and the positive electrode plate and/or between the first separator and the negative electrode plate, and between the second separator and the positive electrode plate and/or between the second separator and the negative electrode plate in the secondary battery, thereby reducing the expansion rate of the secondary battery. Therefore, in the secondary battery of this application, the first separator and the second separator of different types are used in combination, thereby reducing an expansion rate of the secondary battery, and improving the cycle performance, C-rate performance, and safety performance of the secondary battery.

In an embodiment of this application, as shown in FIG. 2, the negative electrode plate 30 includes a negative current collector 31 as well as a first negative electrode material layer 33 and a second negative electrode material layer 34 located on two sides of the negative current collector 31 respectively. Along the winding direction of the electrode assembly, that is, the W direction, one end of the first negative electrode material layer 33 is flush with one end of the second negative electrode material layer 34. The length of the first negative electrode material layer 33 at the other end is greater than the length of the second negative electrode material layer 34 at the other end. The first separator 10 is located on the same side as the first negative electrode material layer 33 of the negative electrode plate 30. The second separator 20 is located on the same side as the second negative electrode material layer 34 of the negative electrode plate 30. In this way, the swelling capacity of the first binder in the electrolyte solution is relatively large, thereby making it convenient for the first separator to store more electrolyte solution. When the first separator is located on the same side as the first negative electrode material layer of the negative electrode plate, it is convenient to adsorb more electrolyte solution on the A side of the negative electrode plate of the secondary battery, thereby reducing the risk of lithium plating at the interface between the electrolyte solution and the negative electrode plate caused by electrolyte flow discontinuity at the later stage of cycling of the secondary battery. In addition, the above structure disposed in the secondary battery can reduce the expansion rate of the secondary battery and improve the cycle performance and C-rate performance of the secondary battery. In this application, the A side of the negative electrode plate means one side, containing the first negative electrode material layer, of the negative electrode plate, that is, the side with a relatively long negative electrode material layer in the negative electrode plate.

In an embodiment of this application, the negative electrode plate includes a negative current collector as well as a first negative electrode material layer and a second negative electrode material layer located on two sides of the negative current collector respectively. Along a winding direction of the electrode assembly, that is, the W direction, the length of the first negative electrode material layer at both ends is greater than the length of the second negative electrode material layer at both ends. The first separator is located on the same side as the first negative electrode material layer of the negative electrode plate. The second separator is located on the same side as the second negative electrode material layer of the negative electrode plate. In this way, the swelling capacity of the first binder in the electrolyte solution is relatively large, thereby making it convenient for the first separator to store more electrolyte solution. When the first separator is located on the same side as the first negative electrode material layer of the negative electrode plate, it is convenient to adsorb more electrolyte solution on the A side of the negative electrode plate of the secondary battery, thereby reducing the risk of lithium plating at the interface between the electrolyte solution and the negative electrode plate caused by electrolyte flow discontinuity at the later stage of cycling of the secondary battery. In addition, the above structure disposed in the secondary battery can reduce the expansion rate of the secondary battery and improve the cycle performance and C-rate performance of the secondary battery.

In an embodiment of this application, the coating weight CW1 of the first bonding layer is 0.0004 mg/mm² to 0.002 mg/mm². For example, the coating weight CW1 of the first bonding layer may be 0.0004 mg/mm², 0.0006 mg/mm², 0.0008 mg/mm², 0.001 mg/mm², 0.0012 mg/mm², 0.0014 mg/mm², 0.0016 mg/mm², 0.0018 mg/mm², 0.002 mg/mm², or a value falling within a range formed by any two thereof. The coating weight CW2 of the second bonding layer is 0.0004 mg/mm² to 0.002 mg/mm². As an example, the coating weight CW2 of the second bonding layer may be 0.0004 mg/mm², 0.0006 mg/mm², 0.0008 mg/mm², 0.001 mg/mm², 0.0012 mg/mm², 0.0014 mg/mm², 0.0016 mg/mm², 0.0018 mg/mm², 0.002 mg/mm², or a value falling within a range formed by any two thereof. By controlling the coating weight CW1 of the first bonding layer and the coating weight CW2 of the second bonding layer within the ranges specified herein, this application achieves relatively high adhesion between the first separator and the positive electrode plate and/or between the first separator and the negative electrode plate, and between the second separator and the positive electrode plate and/or between the second separator and the negative electrode plate, and strengthens the interface between the first separator and the positive electrode plate and/or the interface between the first separator and the negative electrode plate, and the interface between the second separator and the positive electrode plate and/or the interface between the second separator and the negative electrode plate. This facilitates transmission of lithium ions, and further improves the cycle performance, C-rate performance, and safety performance of the secondary battery.

In an embodiment of this application, the average particle diameter D1 of the first binder is 4 μm to 15 μm. As an example, the average particle diameter D1 of the first binder may be 4 μm, 5 μm, 6 μm, 7 μm, 8 μm, 9 μm, 10 μm, 11 μm, 12 μm, 13 μm, 14 μm, 15 μm, or a value falling within a range formed by any two thereof. The average particle diameter D2 of the second binder is 10 μm to 20 μm. As an example, the average particle diameter D2 of the second binder may be 10 μm, 11 μm, 12 μm, 13 μm, 14 μm, 15 μm, 16 μm, 17 μm, 18 μm, 19 μm, 20 μm, or a value falling within a range formed by any two thereof. By controlling the average particle diameter D1 of the first binder and the average particle diameter D2 of the second binder within the ranges specified herein, this application achieves suitable average particle diameters of the first binder and the second binder. In this way, the first bonding layer slurry for preparing the first bonding layer is of a suitable viscosity, and the second bonding layer slurry for preparing the second bonding layer is of a suitable viscosity. Therefore, the first bonding layer and the second bonding layer are of relatively high adhesion, and can strengthen the interface between the first separator and the positive electrode plate and/or the interface between the first separator and the negative electrode plate, and the interface between the second separator and the positive electrode plate and/or the interface between the second separator and the negative electrode plate, thereby facilitating transmission of lithium ions and further improving the cycle performance and C-rate performance of the secondary battery.

In an embodiment of this application, the first negative electrode material layer includes a third binder. The third binder includes at least one of polyvinylidene fluoride, carboxymethyl cellulose (CMC), polyacrylic acid, polyvinyl alcohol, or sodium alginate. The polyvinylidene fluoride may be oil-based polyvinylidene fluoride, and the carboxymethyl cellulose may be water-based carboxymethyl cellulose. The average particle diameter D3 of the third binder is 130 nm to 150 nm. As an example, the average particle diameter D3 of the third binder may be 130 nm, 132 nm, 134 nm, 136 nm, 138 nm, 140 nm, 142 nm, 144 nm, 146 nm, 148 nm, 150 nm, or a value falling within a range formed by any two thereof. By controlling the first negative electrode material layer to include the third binder and controlling the type and average particle diameter D3 of the third binder to fall within the ranges specified herein, the third binder matches the first binder, and the negative electrode plate can be more firmly adhered to the first separator, thereby further improving the cycle performance and safety performance of the secondary battery.

In an embodiment of this application, the second negative electrode material layer includes a fourth binder. The fourth binder includes at least one of polyvinylidene fluoride, carboxymethyl cellulose, polyacrylic acid, polyvinyl alcohol, or sodium alginate. The polyvinylidene fluoride may be oil-based polyvinylidene fluoride, and the carboxymethyl cellulose may be water-based carboxymethyl cellulose. The average particle diameter D4 of the fourth binder is 130 nm to 150 nm. As an example, the average particle diameter D4 of the fourth binder may be 130 nm, 132 nm, 134 nm, 136 nm, 138 nm, 140 nm, 142 nm, 144 nm, 146 nm, 148 nm, 150 nm, or a value falling within a range formed by any two thereof. By controlling the second negative electrode material layer to include the fourth binder and controlling the type and average particle diameter D4 of the fourth binder to fall within the ranges specified herein, the fourth binder matches the second binder, and the negative electrode plate can be more firmly adhered to the second separator, thereby further improving the cycle performance and safety performance of the secondary battery.

In an embodiment of this application, the first negative electrode material layer includes a first negative active material. An average particle diameter D5 of the first negative active material is 11 μm to 24 μm. As an example, the average particle diameter D5 of the first negative active material may be 11 μm, 12 μm, 13 μm, 14 μm, 15 μm, 16 μm, 17 μm, 18 μm, 19 μm, 20 μm, 21 μm, 22 μm, 23 μm, 24 μm, or a value falling within a range formed by any two thereof. The first negative electrode material layer includes a first negative active material. By controlling the average particle diameter D5 of the first negative active material within the range specified herein, the first negative active material possesses a suitable average particle diameter, and a suitable contact area exists between the first negative active material and the first binder in the first separator. In this way, the first separator is of relatively high adhesion to the negative electrode plate, thereby facilitating transmission of lithium ions, further improving the cycle performance and C-rate performance of the secondary battery, and also contributing to a relatively low expansion rate of the secondary battery. In this application, the first negative active material includes at least one of natural graphite, artificial graphite, mesocarbon microbeads (MCMB), hard carbon, soft carbon, silicon, a silicon-carbon composite, SiOₓ (0.5<x<1.6), Li—Sn alloy, Li—Sn—O alloy, Sn, SnO, SnO₂, spinel-structured lithium titanium oxide Li₄Ti₅O₁₂, Li—Al alloy, or metallic lithium.

In an embodiment of this application, the second negative electrode material layer includes a second negative active material. An average particle diameter D6 of the second negative active material is 11 μm to 24 μm. As an example, the average particle diameter D6 of the second negative active material may be 11 μm, 12 μm, 13 μm, 14μ, 15μ, 16 μm, 17 μm, 18μ, 19 μm, 20 μm, 21 μm, 22 μm, 23 μm, 24 μm, or a value falling within a range formed by any two thereof. The second negative electrode material layer includes a second negative active material. By controlling the average particle diameter D6 of the second negative active material within the range specified herein, the second negative active material possesses a suitable average particle diameter, and a suitable contact area exists between the second negative active material and the second binder in the second separator. In this way, the second separator is of relatively high adhesion to the negative electrode plate, thereby facilitating transmission of lithium ions, further improving the cycle performance and C-rate performance of the secondary battery, and also contributing to a relatively low expansion rate of the secondary battery. In this application, the second negative active material includes at least one of natural graphite, artificial graphite, mesocarbon microbeads (MCMB), hard carbon, soft carbon, silicon, a silicon-carbon composite, SiOₓ (0.5<x<1.6), Li—Sn alloy, Li—Sn—O alloy, Sn, SnO, SnO₂, spinel-structured lithium titanium oxide Li₄Ti₅O₁₂, Li—Al alloy, or metallic lithium.

In an embodiment of this application, the first separator further includes a first ceramic coating, and/or, the second separator further includes a second ceramic coating. The first ceramic coating includes a first ceramic particle. The second ceramic coating includes a second ceramic particle. The first ceramic particle and the second ceramic particle each are at least one independently selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide.

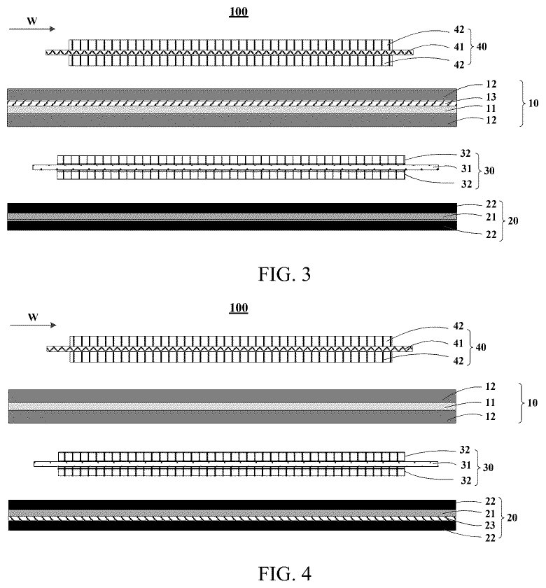

In an embodiment of this application, as shown in FIG. 3, the first separator further includes a first ceramic coating 13 located between the first base film 11 and the first bonding layer 12. The first ceramic coating 13 includes first ceramic particles. The first ceramic particles are at least one selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide. The first separator further includes a first ceramic coating. The type of the first ceramic particles in the first ceramic coating falls within the range specified herein, thereby further improving the thermal stability and mechanical strength of the first separator, effectively alleviating the shrinkage of the first separator at high temperature, and in turn, further improving the safety performance of the secondary battery.

In an embodiment of this application, as shown in FIG. 4, the second separator 20 further includes a second ceramic coating 23 located between the second base film 21 and the second bonding layer 22. The second ceramic coating 23 includes second ceramic particles. The second ceramic particles are at least one selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide. The second separator further includes a second ceramic coating, and the type of the second ceramic particles in the second ceramic coating falls within the range specified herein, thereby further improving the thermal stability and mechanical strength of the second separator, effectively alleviating the shrinkage of the second separator at high temperature, and in turn, further improving the safety performance of the secondary battery.

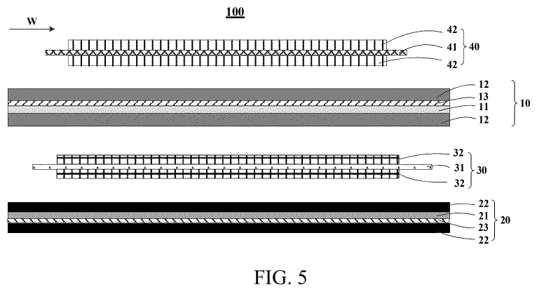

In an embodiment of this application, as shown in FIG. 5, the first separator further includes a first ceramic coating 13 located between the first base film 11 and the first bonding layer 12. The second separator 20 further includes a second ceramic coating 23 located between the second base film 21 and the second bonding layer 22. The first ceramic coating 13 includes a first ceramic particle. The second ceramic coating 23 includes a second ceramic particle. The first ceramic particle and the second ceramic particle each are at least one independently selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide. The first separator further includes a first ceramic coating. The second separator further includes a second ceramic coating. The type of the first ceramic particles in the first ceramic coating and the type of the second ceramic particles in the second ceramic coating fall within the ranges specified herein, thereby further improving the thermal stability and mechanical strength of the first separator and the second separator, effectively alleviating the shrinkage of the first separator and the second separator at high temperature, and in turn, further improving the safety performance of the secondary battery.

In an embodiment of this application, the first ceramic coating further includes a fifth binder, and the second ceramic coating further includes a sixth binder. The types of the fifth binder and the sixth binder are not particularly limited herein, as long as the objectives of this application can be achieved. For example, the fifth binder and the sixth binder each are at least one independently selected from styrene-butadiene rubber, polyvinyl alcohol, polyvinylidene fluoride, polyacrylic acid, polymethyl methacrylate, polybutyl acrylate, or polyacrylonitrile. The content of the first ceramic particles and the content of the fifth binder in the first ceramic coating, and the content of the second ceramic particles and the content of the sixth binder in the second ceramic coating, are not particularly limited herein, and may be selected by a person skilled in the art as actually required, as long as the objectives of this application can be achieved. The coating weights of the first ceramic coating and the second ceramic coating are not particularly limited herein, and may be selected by a person skilled in the art as actually required, as long as the objectives of this application can be achieved. The thicknesses of the first ceramic coating and the second ceramic coating are not particularly limited herein, as long as the objectives of this application can be achieved.

The materials of the first base film and the second base film are not particularly limited herein, as long as the objectives of this application can be achieved. For example, the material of the first base film and the material of the second base film each independently include at least one of polyimide, polyamide, polysulfone, polyacrylonitrile, cellulose, polyetheretherketone, polyphenylene sulfide, polyacrylate ester, polyethylene terephthalate, poly(p-benzamide), polyarylethersulfoneketone, aramid fiber, poly(aromatic sulfone) fiber, or polyolefin; and polymerization monomers of the polyolefin include at least one of ethylene, propylene, 1-butene, 1-pentene, 1-hexene, 1-octene, 4-methyl-1-pentene, cyclobutene, cyclopentene, or cyclohexene. The weight-average molecular weight of the material of the first base film is not particularly limited herein, as long as the objectives of this application can be achieved. For example, the weight-average molecular weight of the material of the first base film is 2×10⁵ to 1.5×10⁶. The weight-average molecular weight of the material of the second base film is not particularly limited herein, as long as the objectives of this application can be achieved. For example, the weight-average molecular weight of the material of the second base film is 2×10⁵ to 1.5×10⁶. The thicknesses of the first base film and the second base film are not particularly limited herein, as long as the objectives of this application can be achieved. In this application, commercially available base films of different materials may be selected, and the first base film and the second base film of desired materials may be selected. The materials are not particularly limited herein, as long as the objectives of this application can be achieved.

The weight-average molecular weight (Mw) of the first binder is not particularly limited herein, as long as the objectives of this application can be achieved. For example, the weight-average molecular weight of the first binder may be 5×10⁵ to 10×10⁶. The weight-average molecular weight of the second binder is not particularly limited herein, as long as the objectives of this application can be achieved. For example, the weight-average molecular weight of the second binder may be 4×10⁵ to 8×10⁶.

In an embodiment of this application, the first bonding layer may include a first thickener, and the second bonding layer may further include a second thickener. Applying the first thickener to the first bonding layer and applying the second thickener to the second bonding layer can increase the stability of the first bonding layer slurry and the second bonding layer slurry, and prevent the sedimentation of each constituent in the first bonding layer slurry and the second bonding layer slurry. The types of the first thickener and the second thickener are not particularly limited herein, as long as the objectives of this application can be achieved. For example, the first thickener and the second thickener each independently are at least one selected from hydroxyethyl cellulose, methyl hydroxyethyl cellulose, sodium carboxymethyl cellulose, polyacrylamide, or sodium alginate. The content of the first thickener in the first bonding layer and the content of the second thickener in the second bonding layer are not particularly limited herein, and may be selected by a person skilled in the art as actually required, as long as the objectives of this application can be achieved. For example, based on the mass of the first bonding layer, the mass percent of the first thickener is 0.3% to 6%; and, based on the mass of the second bonding layer, the mass percent of the second thickener is 0.3% to 6%. The content of the first binder in the first bonding layer and the content of the second binder in the second bonding layer are not particularly limited herein, and may be selected by a person skilled in the art as actually required, as long as the objectives of this application can be achieved. For example, based on the mass of the first bonding layer, the mass percent of the first binder is 94% to 99.7%; and, based on the mass of the second bonding layer, the mass percent of the second binder is 94% to 99.7%. The thicknesses of the first bonding layer and the second bonding layer are not particularly limited herein, as long as the objectives of this application can be achieved. For example, the thickness of the first bonding layer is 1 μm to 2 μm, and the thickness of the second bonding layer is 0.5 μm to 1 μm.

The method for preparing the first separator is not particularly limited herein, as long as the objectives of this application can be achieved. For example, the preparation method of the first separator includes, but is not limited to, the following steps: (1) mixing the first binder with the first thickener well to obtain a first bonding layer slurry; (2) applying the first bonding layer slurry onto a surface of the first base film, and oven-drying the slurry to obtain a first separator coated with the first bonding layer on a single side; and (3) repeating the above steps on the other surface of the first base film to obtain a first separator.

In an embodiment of this application, the preparation method of the first separator may include, but is not limited to, the following steps: (1) mixing the first binder with the first thickener well to obtain a first bonding layer slurry; (2) mixing first ceramic particles with the fifth binder well to obtain a first ceramic coating slurry; (3) applying the first bonding layer slurry onto one surface of the first base film, and performing oven-drying to form a first bonding layer on one surface of the first base film; applying the first ceramic coating slurry onto the other surface of the first base film, and performing oven-drying to form a first ceramic coating on the other surface of the first base film; applying the first bonding layer slurry onto a surface of the first ceramic coating on a side away from the first base film, and performing oven-drying to form another first bonding layer on the surface of the first ceramic coating on the side away from the first base film, thereby obtaining the first separator.

The method for preparing the second separator is not particularly limited herein, as long as the objectives of this application can be achieved. For example, the preparation method of the second separator includes, but is not limited to, the following steps: (1) mixing a second binder with a second thickener well to obtain a second bonding layer slurry; (2) applying the second bonding layer slurry onto one surface of a second base film, and oven-drying the slurry to obtain a second separator coated with the second bonding layer on a single side; and (3) repeating the above steps on the other surface of the second base film to obtain a second separator.

In another embodiment of this application, the preparation method of the second separator may include, but is not limited to, the following steps: (1) mixing a second binder with a second thickener well to obtain a second bonding layer slurry; (2) mixing second ceramic particles with the sixth binder well to obtain a second ceramic coating slurry; and (3) applying the second bonding layer slurry onto one surface of the second base film, and performing oven-drying to form a second bonding layer on one surface of the second base film; applying the second ceramic coating slurry onto the other surface of the second base film, and performing oven-drying to form a second ceramic coating on the other surface of the second base film; applying the second bonding layer slurry onto a surface of the second ceramic coating on a side away from the second base film, and performing oven-drying to form another second bonding layer on the surface of the second ceramic coating on the side away from the second base film, thereby obtaining the second separator.

In this application, the coating weight of the first bonding layer and the coating weight of the second bonding layer may be adjusted by a method known to a person skilled in the art. For example, when the first bonding layer slurry is applied onto the surface of the first base film, with the solid content of the first bonding layer slurry being constant, the coating amount of the first bonding layer slurry is increased to increase the coating weight of the first bonding layer; when the second bonding layer slurry is applied onto the surface of the second base film, with the solid content of the second bonding layer slurry being constant, the coating amount of the second bonding layer slurry is increased to increase the coating weight of the second bonding layer. The adjustment method is not particularly limited herein, as long as the objectives of this application can be achieved.

The methods for regulating the average particle diameter of the first binder and the average particle diameter of the second binder are not particularly limited herein, as long as the objectives of this application can be achieved. For example, a commercially available first binder and second binder with different average particle diameters may be selected, and the average particle diameters of the first binder and the second binder may be determined with reference to the test method of “Determining the average particle diameters of the first binder and the second binder” described herein, and the first binder and the second binder of the desired average particle diameters may be selected.

The methods for regulating the average particle diameter of the third binder and the average particle diameter of the fourth binder are not particularly limited herein, as long as the objectives of this application can be achieved. For example, a commercially available third binder and fourth binder with different average particle diameters may be selected, and the average particle diameters of the third binder and the fourth binder may be determined with reference to the test method of “Determining the average particle diameters of the third binder and the fourth binder” described herein, and the third binder and the fourth binder of the desired average particle diameters may be selected.

The methods for regulating the average particle diameter of the first negative active material and the average particle diameter of the second negative active material are not particularly limited herein, as long as the objectives of this application can be achieved. For example, a commercially available first negative active material and second negative active material with different average particle diameters may be selected, and the average particle diameters of the first negative active material and the second negative active material may be determined with reference to the test method of “Determining the average particle diameters of the first negative active material and the second negative active material” described herein, and the first negative active material and the second negative active material of the desired average particle diameters may be selected.

The negative current collector is not particularly limited herein, as long as the objectives of this application can be achieved. For example, the negative current collector may include copper foil, copper alloy foil, nickel foil, stainless steel foil, titanium foil, foamed nickel, foamed copper, or composite current collector (for example, a lithium-copper composite current collector, a carbon-copper composite current collector, a nickel-copper composite current collector, or a titanium-copper composite current collector), or the like.

In some embodiments of this application, as shown in FIG. 1, the negative electrode plate 30 includes a negative current collector 31 and a negative electrode material layer 32 disposed on both surfaces of the negative current collector 31. The negative electrode material layer includes a negative active material. The negative active material is not particularly limited herein, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ (0.5<x<1.6), Li—Sn alloy, Li—Sn—O alloy, Sn, SnO, SnO₂, spinel-structured lithium titanium oxide Li₄Ti₅O₁₂, Li—Al alloy, or metallic lithium. The negative electrode material layer of this application further includes a negative electrode binder. The negative electrode binder is not particularly limited herein, as long as the objectives of this application can be achieved. For example, the negative electrode binder may include at least one of polyacrylate ester, polyimide, polyamide, polyamideimide, polyvinylidene fluoride, poly(styrene-co-butadiene) (styrene-butadiene rubber), sodium alginate, polyvinyl alcohol, polytetrafluoroethylene, polyacrylonitrile, sodium carboxymethylcellulose, potassium carboxymethylcellulose, hydroxymethyl cellulose, sodium hydroxymethyl cellulose, or potassium hydroxymethyl cellulose. The negative electrode material layer of this application further includes a conductive agent. The conductive agent is not particularly limited herein, as long as the objectives of this application can be achieved. For example, the conductive agent may include, but is not limited to, at least one of conductive carbon black, carbon nanotubes (CNTs), carbon fibers, flake graphite, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The mass percentages of the negative active material, the negative electrode binder, and the conductive agent in the negative electrode material layer are not particularly limited herein, and may be selected by a person skilled in the art as actually required, as long as the objectives of this application can be achieved.

In this application, the first negative electrode material layer and the second negative electrode material layer each further include a conductive agent. The types of the conductive agents in the first negative electrode material layer and the second negative electrode material layer are not particularly limited herein as long as the objectives of this application can be achieved, for example, may be at least one of the above conductive agents. The mass percentages of the first negative active material, the third binder, and the conductive agent in the first negative electrode material layer are not particularly limited herein, and may be selected by a person skilled in the art as actually required, as long as the objectives of this application can be achieved. For example, based on the mass of the first negative electrode material layer, the mass percent of the first negative active material is 97.5% to 98.8%, the mass percent of the third binder is 0.1% to 1%, and the mass percent of the conductive agent is 0.2% to 1.5%. The mass percentages of the second negative active material, the fourth binder, and the conductive agent in the second negative electrode material layer are not particularly limited herein, and may be selected by a person skilled in the art as actually required, as long as the objectives of this application can be achieved. For example, based on the mass of the second negative electrode material layer, the mass percent of the second negative active material is 97.5% to 98.8%, the mass percent of the fourth binder is 0.1% to 1%, and the mass percent of the conductive agent is 0.2% to 1.5%.

The thickness of the negative current collector is not particularly limited herein as long as the objectives of this application can be achieved. For example, the thickness of the negative current collector is 4 μm to 15 μm. The thicknesses of the negative electrode material layer, the first negative electrode material layer, and the second negative electrode material layer are not particularly limited herein, as long as the objectives of this application can be achieved. For example, the thickness of the negative electrode material layer on a single side is 30 μm to 130 μm, the thickness of the first negative electrode material layer on a single side is 30 μm to 130 μm, and the thickness of the second negative electrode material layer on a single side is 30 μm to 130 μm.

In this application, the positive electrode plate includes a positive current collector and a positive electrode material layer disposed on at least one surface of the positive current collector. The “positive electrode material layer disposed on at least one surface of the positive current collector” means that the positive electrode material layer may be disposed on one surface of the positive current collector or on both surfaces of the positive current collector along the thickness direction of the current collector. It is hereby noted that the “surface” here may be the entire region of the positive current collector, or a partial region of the positive current collector, without being particularly limited herein, as long as the objectives of the application can be achieved. As an example, as shown in FIG. 1 to FIG. 5, a positive electrode plate 40 includes a positive current collector 41 and a positive electrode material layer 42 disposed on both surfaces of the positive current collector 41. The positive current collector is not particularly limited herein, as long as the objectives of this application can be achieved. For example, the positive current collector may include aluminum foil, aluminum alloy foil, a composite current collector (for example, an aluminum-carbon composite current collector), or the like.

The positive electrode material layer of this application includes a positive active material. The positive active material includes a substance in which active ions such as lithium ions can be reversibly intercalated and deintercalated. The positive electrode material layer may be one layer or a plurality of layers. Each layer in the plurality of positive electrode material layers may contain the same or different positive active materials. The positive active material is not particularly limited herein as long as the objectives of this application can be achieved. For example, the positive active material may include, but is not limited to, at least one of lithium nickel cobalt manganese oxide (for example, NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, or lithium titanium oxide. The positive electrode material layer of this application further includes a conductive agent and a positive electrode binder. The types of the conductive agent and the positive electrode binder in the positive electrode material layer are not particularly limited herein, as long as the objectives of this application can be achieved. For example, the conductive agent may include at least one of the above conductive agents, and the positive electrode binder may include at least one of the above negative electrode binders. The mass percentages of the positive active material, the conductive agent, and the positive electrode binder in the positive electrode material layer are not particularly limited herein, and may be selected by a person skilled in the art as actually required, as long as the objectives of this application can be achieved.

The thickness of the positive current collector is not particularly limited herein as long as the objectives of this application can be achieved. For example, the thickness of the positive current collector is 9 μm to 15 μm. The thickness of the positive electrode material layer is not particularly limited herein, as long as the objectives of this application can be achieved. For example, the thickness of the positive electrode material layer on a single side is 30 μm to 120 μm.

Optionally, the positive electrode plate may further include a conductive layer. The conductive layer is located between the positive current collector and the positive electrode material layer. The constituents of the conductive layer are not particularly limited herein, and the conductive layer may be a conductive layer commonly used in the art. The conductive layer includes a conductive agent and a binder. The conductive agent and binder in the conductive layer are not particularly limited herein, and may be at least one of the conductive agents and positive electrode binders enumerated above. The mass percentages of the conductive agent and binder in the conductive layer are not particularly limited herein, and may be selected by a person skilled in the art as actually required, as long as the objectives of this application can be achieved.

In this application, the secondary battery further includes an electrolyte solution. The electrolyte solution includes a lithium salt. The type of the lithium salt is not particularly limited herein, and may be a lithium salt known in the art. As an example, the lithium salt may include, but is not limited to, at least one of lithium hexafluorophosphate (LiPF₆), lithium bistrifluoromethanesulfonimide LiN(CF₃SO₂)₂ (LiTFSI), lithium bis(fluorosulfonyl)imide Li(N(SO₂F)₂) (LiFSI), lithium difluorophosphate (LiPO₂F₂), lithium bis(oxalate) borate LiB(C₂O₄)₂ (LiBOB), or lithium difluoro (oxalate) borate LiBF₂(C₂O₄) (LiDFOB). The mass percent of the lithium salt in the electrolyte solution is not particularly limited herein, as long as the objectives of this application can be achieved. The electrolyte solution includes a nonaqueous organic solvent. The nonaqueous organic solvent is not particularly limited herein, as long as the objectives of this application can be achieved. For example, the nonaqueous organic solvent may include at least one of a carbonate ester compound, a carboxylate ester compound, an ether compound, or another organic solvent. The carbonate compound may include, but is not limited to, at least one of a chain carbonate ester compound, a cyclic carbonate ester compound, or a fluorocarbonate ester compound. The chain carbonate compound may include, but is not limited to, at least one of dimethyl carbonate (DMC), diethyl carbonate (DEC), dipropyl carbonate (DPC), methyl propyl carbonate (MPC), ethylene propyl carbonate (EPC), or ethyl methyl carbonate (EMC). The cyclic carbonate ester compound may include, but is not limited to, at least one of ethylene carbonate (EC), propylene carbonate (PC), butylene carbonate (BC), or vinyl ethylene carbonate (VEC). The fluorocarbonate ester compound may include, but is not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, or propyl propionate. The ether compound may include, but is not limited to, at least one of dibutyl ether, tetraglyme, diglyme, 1,2-dimethoxyethane, 1,2-diethoxyethane, ethoxymethoxyethane, 2-methyltetrahydrofuran, or tetrahydrofuran. The other organic solvent may include, but without being limited to, at least one of dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, or phosphate ester. The mass percent of the nonaqueous organic solvent in the electrolyte solution is not particularly limited herein, as long as the objectives of this application can be achieved.

The secondary battery of this application further includes a packaging bag. The packaging bag is configured to accommodate a positive electrode plate, a negative electrode plate, a separator, an electrolyte solution, and other components known in the art for use in a secondary battery. Such other components are not limited herein. The packaging bag is not particularly limited herein, and may be a packaging bag well-known in the art, as long as the objectives of this application can be achieved. For example, the pocket may be an aluminum laminated film.

The secondary battery is not particularly limited in this application, and may be any device in which an electrochemical reaction occurs. In an embodiment of this application, the secondary battery may be, but is not limited to, a lithium-ion secondary battery (lithium-ion battery), a lithium polymer secondary battery, a lithium-ion polymer secondary battery, or the like.

The method for preparing the secondary battery is not particularly limited herein, and may be any preparation method well-known in the art, as long as the objectives of this application can be achieved. For example, the method for preparing the secondary battery includes, but is not limited to, the following steps: stacking the positive electrode plate, the first separator, the negative electrode plate, and the second separator in sequence, and performing operations such as winding and folding as required on the stacked structure to obtain a jelly-roll electrode assembly; putting the electrode assembly into a packaging bag, injecting an electrolyte solution into the packaging bag, and sealing the package bag to obtain a secondary battery. For example, the method for preparing the secondary battery includes, but is not limited to, the following steps: stacking the first separator, the negative electrode plate, and the second separator, and the positive electrode plate in sequence, and performing operations such as winding and folding as required on the stacked structure to obtain a jelly-roll electrode assembly; putting the electrode assembly into a packaging bag, injecting an electrolyte solution into the packaging bag, and sealing the package bag to obtain a secondary battery.

A second aspect of this application provides an electronic device. The electronic device includes the secondary battery disclosed in any one of the preceding embodiments. The secondary battery of this application exhibits a relatively low expansion rate and a relatively high level of cycle performance, C-rate performance, and safety performance. Therefore, the electronic device of this application is of high operating performance.

The electronic device is not particularly limited herein, and may be any electronic device known in the prior art. For example, the electronic device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to embodiments and comparative embodiments. Various tests and evaluations are performed by the following methods. In addition, unless otherwise specified, the word “parts” means parts by mass, and the symbol “%” means a percentage by mass.

### Test Methods and Devices

### Method for Sampling First Separators and Second Separators

Disassembling a lithium-ion battery in each embodiment and comparative embodiment to be tested, taking out a first separator and a second separator, and soaking the separators in dimethyl carbonate (DMC) for 20 minutes to remove residual electrolyte solution. Subsequently, drying the first separator and the second separator in an oven at 60° C. for 12 hours to obtain a first separator sample and a second separator sample. The samples of the first separator and the second separator in the following process of determining the average particle diameters of the first binder and the second binder are obtained by using the above method.

### Determining the Average Particle Diameters of the First Binder and the Second Binder

For the average particle diameters of the first binder and the second binder, a surface, perpendicular to the thickness direction, of the first separator and a surface, perpendicular to the thickness direction, of the second separator may be observed by using a scanning electron microscope (SEM). 10 first binder particles are randomly selected in the first bonding layer to obtain the average particle diameter D1 of the first binder, and 10 second binder particles are randomly selected in the second bonding layer to obtain the average particle diameter D2 of the second binder. It is worth noting that the particles of the first binder and the second binder are deformed under the pressure during cold-pressing, hot-pressing, and other processes in the preparation of the lithium-ion battery, so that the diameter of a particle along the thickness direction of the separator is different from the diameter of the particle along a direction perpendicular to the thickness direction of the separator. The average particle diameter of the first binder particles and the average particle diameter of the second binder particles in this application each mean a diameter measured on a surface, perpendicular to the thickness direction of the separator, of the particle. Therefore, the average particle diameter of the first binder particles and the average particle diameter of the second binder particles are not limited by the thicknesses of the first bonding layer and the second bonding layer.

### Determining the Average Particle Diameters of the Third Binder and the Fourth Binder

The particle diameter of the third binder is measured by using a Malvern particle size analyzer (MasterSizer 2000) according to the following process: Adding 0.02 g of the third binder into a 50 mL clean beaker, adding 20 mL of ethanol dispersant, and sonicating the mixture in a 120 W ultrasonic cleaning machine for 30 min to completely disperse the third binder in the ethanol to obtain a sample dispersion. Testing the sample dispersion by using a Malvern particle diameter analyzer to obtain a particle diameter Dᵥ₅₀ of the third binder. The particle diameter Dᵥ₅₀ of the third binder is the average particle diameter D3 of the third binder.

The particle diameter of the fourth binder is measured by using a Malvern particle size analyzer (MasterSizer 2000) according to the following process: Adding 0.02 g of the fourth binder into a 50 mL clean beaker, adding 20 mL of ethanol dispersant, and sonicating the mixture in a 120 W ultrasonic cleaning machine for 30 min to completely disperse the fourth binder in the ethanol to obtain a sample dispersion. Testing the sample dispersion by using a Malvern particle diameter analyzer to obtain a particle diameter Dᵥ₅₀ of the fourth binder. The particle diameter Dᵥ₅₀ of the fourth binder is the average particle diameter D4 of the fourth binder.

### Determining the Average Particle Diameters of the First Negative Active Material and the Second Negative Active Material

The particle diameter of the first negative active material is measured by using a Malvern particle size analyzer (MasterSizer 2000) according to the following process: Adding 0.02 g of the first negative active material into a 50 mL clean beaker, adding 20 mL of ethanol dispersant, and sonicating the mixture in a 120 W ultrasonic cleaning machine for 30 min to completely disperse the first negative active material in the ethanol to obtain a sample dispersion. Testing the sample dispersion by using a Malvern particle diameter analyzer to obtain a particle diameter Dᵥ₅₀ of the first negative active material. The particle diameter Dᵥ₅₀ of the first negative active material is the average particle diameter D5 of the first negative active material.

The particle diameter of the second negative active material is measured by using a Malvern particle size analyzer (MasterSizer 2000) according to the following process: Adding 0.02 g of the second negative active material into a 50 mL clean beaker, adding 20 mL of ethanol dispersant, and sonicating the mixture in a 120 W ultrasonic cleaning machine for 30 min to completely disperse the second negative active material in the ethanol to obtain a sample dispersion. Testing the sample dispersion by using a Malvern particle diameter analyzer to obtain a particle diameter Dᵥ₅₀ of the second negative active material. The particle diameter Dᵥ₅₀ of the second negative active material is the average particle diameter D6 of the second negative active material.

### Determining the Thickness of the Lithium-Ion Battery

Adjusting, by adding or removing a weight, the test pressure to 600 g, placing a 3 mm gauge block onto a loading platform, pressing the white buttons on both sides of the instrument so that the parallel plate gauge (PPG battery thickness gauge) automatically feeds the gauge block into the instrument and tests the thickness. Measuring any 9 points in sequence, with a calibration tolerance of ±0.02 mm. Using only the item that falls within the specification range. Holding the lithium-ion battery with one hand, placing the battery on the loading platform with the barcode facing up. Scanning the barcode first, and then pressing the white buttons on both sides so that the instrument automatically feeds the lithium-ion battery for testing. Recording the test result, that is, the thickness THK of the lithium-ion battery. In this application, the smaller the thickness of the lithium-ion battery, the smaller the volume of the lithium-ion battery, and the higher the energy density of the lithium-ion battery.

### Testing the Cycle Performance

Charging a lithium-ion battery at a constant current of 2C at 25° C. until the voltage reaches 4.5 V, and then charging the battery at a constant voltage of 4.5 V until the current tapers off to 0.02 C. Leaving the battery to stand for 5 minutes, and then discharging the battery at a constant current of 0.7C until the voltage drops to 3.0 V, thereby completing a first cycle. Recording the discharge capacity at this time. Charging and discharging the lithium-ion battery according to the above process until completion of 1000 cycles (cls). Calculating the capacity retention rate as a metric of the cycle performance of the lithium-ion battery.

1000^{th}-cycle capacity retention rate(%)=(1000th-cycle discharge capacity/first-cycle discharge capacity)×100%.

### Testing the C-Rate Performance

Charging a lithium-ion battery at a constant current of 2C in a 25° C. environment until the voltage reaches 4.5 V, and then charging the battery at a constant voltage of 4.5 V until the current drops to 0.02C, leaving the battery to stand for 5 minutes, and then discharging the battery at a constant current of 0.2C until the voltage drops to 3 V. Recording the discharge capacity at this time as a 0.2C discharge capacity. Leaving the battery to stand for 5 minutes, and then charging the battery at a constant current of 2C until the voltage reaches 4.5 V, and then charging the battery at a constant voltage of 4.5 V until the current drops to 0.02C. Leaving the battery to stand for 5 minutes, and then discharging the battery at a constant current of 1C until the voltage drops to 3 V. Recording the discharge capacity at this time as a 1C discharge capacity. Leaving the battery to stand for 5 minutes, and then charging the battery at a constant current of 2C until the voltage reaches 4.5 V, and then charging the battery at a constant voltage of 4.5 V until the current drops to 0.02C. Leaving the battery to stand for 5 minutes, and then discharging the battery at a constant current of 2C until the voltage drops to 3 V. Recording the discharge capacity at this time as a 2C discharge capacity.

1C discharge capacity retention rate of the lithium-ion battery(%)=1C discharge capacity/0.2C discharge capacity×100%.

2C discharge capacity retention rate of the lithium-ion battery(%)=2C discharge capacity/0.2C discharge capacity×100%.

### Hot-Oven Test

Charging a lithium-ion battery at 25° C. at a constant current of 2C until the voltage reaches 4.5 V, and then charging the battery at a constant voltage of 4.5 V until the current tapers off to 0.02C. Subsequently, leaving the lithium-ion battery to stand for 5 minutes in a test chamber ventilated with air at a temperature of 25° C. and a humidity of 80%, and then heating the test chamber to 130° C. at a rate of 5° C./min. Keeping the temperature constant at 130° C. for 10 minutes, and then checking whether the lithium-ion battery catches fire or explodes. Determining that the battery passes the test if the battery does not catch fire or explode. Calculating the 130° C. hot-oven test pass rate as: hot-oven test pass rate=number of batteries passing the 130° C. hot-oven test/10 (total number of batteries tested in 130° C. hot oven).

Charging a lithium-ion battery at 25° C. at a constant current of 2C until the voltage reaches 4.5 V, and then charging the battery at a constant voltage of 4.5 V until the current tapers off to 0.02C. Subsequently, leaving the lithium-ion battery to stand for 5 minutes in a test chamber ventilated with air at a temperature of 25° C. and a humidity of 80%, and then heating the test chamber to 132° C. at a rate of 5° C./min. Keeping the temperature constant at 132° C. for 10 minutes, and then checking whether the lithium-ion battery catches fire or explodes. Determining that the battery passes the test if the battery does not catch fire or explode. Calculating the 132° C. hot-oven test pass rate as: hot-oven test pass rate=number of batteries passing the 132° C. hot-oven test/10 (total number of batteries tested in 132° C. hot oven).

### Embodiment 1-1

### <Preparing a First Separator>

Using a 7 μm-thick microporous film as a first base film, where the material of the microporous film is polypropylene and polyethylene mixed at a mass ratio of 1:1, and the porosity of the first base film is 18% (manufacturer: Celgard, designation: 2325).

Mixing poly(vinylidene fluoride-co-hexafluoropropylene copolymer) (PVDF-HFP, with weight-average molecular weight Mw=8.5×10⁶) as a first binder and sodium carboxymethyl cellulose (Mw=8×10⁵) as a first thickener at a mass ratio of 98.5:1.5, adding deionized water as a solvent, and stirring well to form a first bonding layer slurry in which the solid content is 75 wt %.

Applying the first bonding layer slurry onto one surface of the first base film, and oven-drying the slurry at 60° C. to obtain a first separator coated with the first bonding layer on a single side. Subsequently, repeating the above steps on the other surface of the first base film to obtain a first separator. The average particle diameter D1 of the first binder is 9 μm, and the coating weight CW1 of the first bonding layer is 0.002 mg/mm².

### <Preparing a Second Separator>

Using a 7 μm-thick microporous film as a second base film, where the material of the microporous film is polypropylene and polyethylene mixed at a mass ratio of 1:1, and the porosity of the second base film is 18% (manufacturer: Celgard, designation: 2325).

Mixing polyimide (PI, with weight-average molecular weight Mw=7×10⁵) as a second binder and sodium carboxymethyl cellulose (Mw=8×10⁵) as a second thickener at a mass ratio of 98.5:1.5, adding deionized water as a solvent, and stirring well to form a second bonding layer slurry in which the solid content is 75 wt %.

Applying the second bonding layer slurry onto one surface of the second base film, and oven-drying the slurry at 60° C. to obtain a second separator coated with the second bonding layer on a single side. Subsequently, repeating the above steps on the other surface of the second base film to obtain a second separator. The average particle diameter D2 of the second binder is 16 μm, and the coating weight CW2 of the second bonding layer is 0.0008 mg/mm².

### <Preparing a Negative Electrode Plate>

Mixing artificial graphite as a first negative active material, carboxymethyl cellulose (CMC) as a third binder, and conductive carbon black as a conductive agent at a mass ratio of 97.6:1.1:1.3, adding deionized water as a solvent, and stirring well to obtain a first negative electrode slurry in which the solid content is 70 wt %. At the same time, the first negative electrode slurry also serves as a second negative electrode slurry. In other words, the second negative active material is the same as the first negative active material, and the fourth binder is the same as the third binder. Applying the first negative electrode slurry onto one surface of a 6 μm-thick negative current collector copper foil, and oven-drying the slurry at 90° C. to obtain a negative electrode plate coated with a 50 μm-thick first negative electrode material layer. Applying the second negative electrode slurry onto the other surface of the negative current collector copper foil, and oven-drying the slurry to obtain a 106 μm-thick negative electrode plate coated with a 50 μm-thick second negative electrode material layer. Cold-pressing and then cutting the coated negative electrode plate into sheets of 74 mm×824 mm in size for future use. The compaction density of the first negative electrode material layer is 1.735 g/cm³, and the length of the first negative electrode material layer is 720 mm. The compaction density of the second negative electrode material layer is 1.735 g/cm³, and the length of the second negative electrode material layer is 680 mm. The average particle diameter D3 of the third binder is 140 nm, and the average particle diameter D4 of the fourth binder is 140 nm. The average particle diameter D5 of the first negative active material is 20 μm, and the average particle diameter D6 of the second negative active material is 20 μm. The carboxymethyl cellulose as a third binder is water-based carboxymethyl cellulose.

### <Preparing a Positive Electrode Plate>

Mixing lithium cobalt oxide as a positive active material, conductive carbon black as a conductive agent, and polyvinylidene fluoride as a positive electrode binder at a mass ratio of 95:2.5:2.5, and then adding N-methyl pyrrolidone (NMP) as a solvent, stirring well to obtain a positive electrode slurry in which the solid content is 75 wt %. Applying the positive electrode slurry evenly onto one surface of a 10 μm-thick positive current collector aluminum foil, and oven-drying the slurry at 90° C. to obtain a positive electrode plate coated with a 55 μm-thick positive electrode material layer on a single side. Applying the positive electrode slurry onto the other surface of the positive current collector aluminum foil, and oven-drying the slurry to obtain a 120 μm-thick positive electrode plate coated with a 55 μm-thick positive electrode material layer on both sides. Cold-pressing and then cutting the coated positive electrode plate into sheets of 70 mm×800 mm in size for future use. The compaction density of the positive electrode material layer is 4.23 g/cm³.

### <Preparing an Electrolyte Solution>

Mixing propylene carbonate (PC), diethyl carbonate (DEC), and ethylene carbonate (EC) at a mass ratio of 1:1:1 in a dry argon atmosphere glovebox to form a base solvent, and then adding hexafluorophosphate (LiPF₆) as a lithium salt into the base solvent to dissolve, and stirring well to obtain an electrolyte solution. Based on the mass of the electrolyte solution, the mass percent of LiPF₆ is 13%, and the remainder is the base solvent.

### <Preparing a Lithium-Ion Battery>

Stacking the above-prepared positive electrode plate, first separator, negative electrode plate, and second separator in sequence, and then winding the stacked structure to obtain an electrode assembly. Leading out a positive tab by spot-welding the aluminum foil, and leading out a negative tab by spot-welding the nickel foil. The first negative electrode material layer is close to the first separator, and the second negative electrode material layer is close to the second separator. Putting the electrode assembly into an aluminum laminated film, leaving the electrode assembly in an 80° C. vacuum oven for 12 hours to dehydrate, and then injecting the above-prepared electrolyte solution to form a cell. Performing vacuum sealing, standing, chemical formation (charging the cell at a constant current of 0.02C until the voltage reaches 3.5 V, and then charging the cell at a constant current of 0.1C until the voltage reaches 3.9 V), capacity grading, and shaping to obtain a lithium-ion battery.

### Embodiments 1-2 to 1-4

Identical to Embodiment 1-1 except that the relevant preparation parameters are adjusted according to Table 1.

### Embodiments 1-5 to 1-9

Identical to Embodiment 1-1 except that the coating amount of the first bonding layer slurry is adjusted so that the coating weight of the first bonding layer meets the value specified in Table 1, and the coating amount of the second bonding layer slurry is adjusted so that the coating weight of the second bonding layer meets the value specified in Table 1.

### Embodiments 1-10 to 1-13

Identical to Embodiment 1-1 except that the relevant preparation parameters are adjusted according to Table 1.

### Embodiment 1-14

Identical to Embodiment 1-1 except that the lithium-ion battery is prepared according to the following steps:

### <Preparing a Lithium-Ion Battery>

Stacking the prepared positive electrode plate, first separator, negative electrode plate, and second separator in sequence, and then winding the stacked structure to obtain an electrode assembly. Leading out a positive tab by spot-welding the aluminum foil, and leading out a negative tab by spot-welding the nickel foil. The first negative electrode material layer is close to the second separator, and the second negative electrode material layer is close to the first separator. Putting the electrode assembly into an aluminum laminated film, leaving the electrode assembly in an 80° C. vacuum oven for 12 hours to dehydrate, and then injecting the above-prepared electrolyte solution to form a cell. Performing vacuum sealing, standing, chemical formation (charging the cell at a constant current of 0.02C until the voltage reaches 3.5 V, and then charging the cell at a constant current of 0.1C until the voltage reaches 3.9 V), capacity grading, and shaping to obtain a lithium-ion battery.

### Embodiment 1-15

Identical to Embodiment 1-1 except that the first separator is prepared according to the following steps, and in <Preparing a lithium-ion battery>, one side, coated with only the first bonding layer, of the first separator is close to the negative electrode plate.

### <Preparing a First Separator>

Using a 7 μm-thick microporous film as a first base film, where the material of the microporous film is polypropylene and polyethylene mixed at a mass ratio of 1:1, and the porosity of the first base film is 18% (manufacturer: Celgard, designation: 2325).

Mixing poly(vinylidene fluoride-co-hexafluoropropylene copolymer) (PVDF-HFP, with weight-average molecular weight Mw=8.5×10⁶) as a first binder and sodium carboxymethyl cellulose (Mw=8×10⁵) as a first thickener at a mass ratio of 98.5:1.5, adding deionized water as a solvent, and stirring well to form a first bonding layer slurry in which the solid content is 75 wt %.

Mixing aluminum oxide (Al₂O₃) as first ceramic particles, styrene-butadiene rubber (Mw=7×10⁶) as the fifth binder, and a deionized water solvent at a mass ratio of 35:10:55 to obtain a first ceramic coating slurry.

Applying the first bonding layer slurry onto one surface of the first base film, and performing oven-drying at 60° C. to form a first bonding layer on one surface of the first base film; applying the first ceramic coating slurry onto the other surface of the first base film, and performing oven-drying at 60° C. to form a first ceramic coating on the other surface of the first base film; applying the first bonding layer slurry onto a surface of the first ceramic coating on a side away from the first base film, and performing oven-drying to form another first bonding layer on the surface of the first ceramic coating on the side away from the first base film, thereby obtaining the first separator. The average particle diameter D1 of the first binder is 9 μm, the coating weight CW1 of the first bonding layer is 0.002 mg/mm²; and the coating weight of the first ceramic coating is 0.09 mg/mm².

### Embodiment 1-16

Identical to Embodiment 1-1 except that the second separator is prepared according to the following steps, and in <Preparing a lithium-ion battery>, one side, coated with only the second bonding layer, of the second separator is close to the negative electrode plate.

### <Preparing a Second Separator>

Using a 7 μm-thick microporous film as a second base film, where the material of the microporous film is polypropylene and polyethylene mixed at a mass ratio of 1:1, and the porosity of the second base film is 18% (manufacturer: Celgard, designation: 2325).

Mixing polyimide (PI, with weight-average molecular weight Mw=6×10⁵) as a second binder and sodium carboxymethyl cellulose (Mw=8×10⁵) as a second thickener at a mass ratio of 98.5:1.5, adding deionized water as a solvent, and stirring well to form a second bonding layer slurry in which the solid content is 75 wt %.

Mixing aluminum oxide (Al₂O₃) as second ceramic particles, styrene-butadiene rubber (Mw=7×10⁶) as the sixth binder, and a deionized water solvent at a mass ratio of 35:10:55 to obtain a second ceramic coating slurry.

Applying the second bonding layer slurry onto one surface of the second base film, and performing oven-drying at 60° C. to form a second bonding layer on one surface of the second base film; applying the second ceramic coating slurry onto the other surface of the second base film, and performing oven-drying at 60° C. to form a second ceramic coating on the other surface of the second base film; applying the second bonding layer slurry onto a surface of the second ceramic coating on a side away from the second base film, and performing oven-drying to form another second bonding layer on the surface of the second ceramic coating on the side away from the second base film, thereby obtaining the second separator. The average particle diameter D2 of the second binder is 16 μm, the coating weight CW2 of the second bonding layer is 0.0008 mg/mm²; and the coating weight of the second ceramic coating is 0.09 mg/mm².

### Embodiment 1-17

Identical to Embodiment 1-1 except that: the first separator is the first separator used in Embodiment 1-15; the second separator is the second separator used in Embodiment 1-16; and the lithium-ion battery is prepared according to the following steps:

### <Preparing a Lithium-Ion Battery>

Stacking the prepared positive electrode plate, first separator, negative electrode plate, and second separator in sequence, and then winding the stacked structure to obtain an electrode assembly. Leading out a positive tab by spot-welding the aluminum foil, and leading out a negative tab by spot-welding the nickel foil. A side, coated with only the first bonding layer, of the first separator is close to the negative electrode plate. A side, coated with only the second bonding layer, of the second separator is close to the negative electrode plate. The first negative electrode material layer is close to the first separator, and the second negative electrode material layer is close to the second separator. Putting the electrode assembly into an aluminum laminated film, leaving the electrode assembly in an 80° C. vacuum oven for 12 hours to dehydrate, and then injecting the above-prepared electrolyte solution to form a cell. Performing vacuum sealing, standing, chemical formation (charging the cell at a constant current of 0.02C until the voltage reaches 3.5 V, and then charging the cell at a constant current of 0.1C until the voltage reaches 3.9 V), capacity grading, and shaping to obtain a lithium-ion battery.

### Embodiments 2-1 to 2-10

Identical to Embodiment 1-1 except that the relevant preparation parameters are adjusted according to Table 2.

### Comparative Embodiments 1 to 2

Identical to Embodiment 1-1 except that the relevant preparation parameters are adjusted according to Table 1.

Table 1 to Table 2 show the preparation parameters and performance parameters of each embodiment and each comparative embodiment.

TABLE 1

| | | | | | | | | | | 1000^{th}- | 130° | 132° |
|---|---|---|---|---|---|---|---|---|---|---|---|---|
| | | | | | | | | 1 C | 2 C | cycle | C. hot- | C. hot- |
| | | | | | | | | discharge | discharge | capacity | oven | oven |
| | | | | | | | | capacity | capacity | retention | test | test |
| | First | Second | CW1 | CW2 | D1 | D2 | THK | retention | retention | rate | pass | pass |
| | binder | binder | (mg/mm²) | (mg/mm²) | (μm) | (μm) | (mm) | rate (%) | rate (%) | (%) | rate | rate |
| Embodiment 1-1 | PVDF-HFP | PI | 0.002 | 0.0008 | 9 | 16 | 4.71 | 95.12 | 85.34 | 86.25 | 10/10 | 8/10 |
| Embodiment 1-2 | PVDF | PI | 0.002 | 0.0008 | 9 | 16 | 4.71 | 94.98 | 85.22 | 86.12 | 10/10 | 5/10 |
| Embodiment 1-3 | PVDF-HFP | PVA | 0.002 | 0.0008 | 9 | 16 | 4.71 | 95.11 | 85.12 | 85.98 | 10/10 | 3/10 |
| Embodiment 1-4 | PVDF-HFP | CMC-Na | 0.002 | 0.0008 | 9 | 16 | 4.71 | 95.1 | 85.15 | 86.16 | 10/10 | 4/10 |
| Embodiment 1-5 | PVDF-HFP | PI | 0.0004 | 0.0004 | 9 | 16 | 4.69 | 94.3 | 85.2 | 85.12 | 10/10 | 6/10 |
| Embodiment 1-6 | PVDF-HFP | PI | 0.0012 | 0.0012 | 9 | 16 | 4.72 | 95.2 | 85.3 | 85.4 | 10/10 | 7/10 |
| Embodiment 1-7 | PVDF-HFP | PI | 0.002 | 0.002 | 9 | 16 | 4.73 | 95 | 85 | 85 | 10/10 | 8/10 |
| Embodiment 1-8 | PVDF-HFP | PI | 0.0002 | 0.0002 | 9 | 16 | 4.68 | 95.3 | 85.4 | 86.2 | 10/10 | 3/10 |
| Embodiment 1-9 | PVDF-HFP | PI | 0.004 | 0.004 | 9 | 16 | 4.76 | 94.8 | 84.3 | 84.3 | 10/10 | 9/10 |
| Embodiment 1-10 | PVDF-HFP | PI | 0.002 | 0.0008 | 4 | 10 | 4.68 | 96.1 | 86.2 | 87.5 | 10/10 | 8/10 |
| Embodiment 1-11 | PVDF-HFP | PI | 0.002 | 0.0008 | 15 | 20 | 4.81 | 93.9 | 85.2 | 87 | 10/10 | 9/10 |
| Embodiment 1-12 | PVDF-HFP | PI | 0.002 | 0.0008 | 3 | 8 | 4.61 | 95.25 | 85.98 | 86.56 | 10/10 | 3/10 |
| Embodiment 1-13 | PVDF-HFP | PI | 0.002 | 0.0008 | 17 | 22 | 4.89 | 94.96 | 85.7 | 85.43 | 10/10 | 9/10 |
| Embodiment 1-14 | PVDF-HFP | PI | 0.002 | 0.0008 | 9 | 16 | 4.71 | 89.88 | 81.2 | 82.9 | 10/10 | 8/10 |
| Embodiment 1-15 | PVDF-HFP | PI | 0.002 | 0.0008 | 9 | 16 | 4.73 | 96.8 | 86.7 | 88.6 | 10/10 | 10/10 |
| Embodiment 1-16 | PVDF-HFP | PI | 0.002 | 0.0008 | 9 | 16 | 4.73 | 97.5 | 87.9 | 89.9 | 10/10 | 10/10 |
| Embodiment 1-17 | PVDF-HFP | PI | 0.002 | 0.0008 | 9 | 16 | 4.75 | 98.8 | 89 | 90.43 | 10/10 | 10/10 |
| Comparative | PI | PI | 0.0008 | 0.0008 | 16 | 16 | 4.77 | 80.23 | 79.1 | 75.67 | 10/10 | 10/10 |
| Embodiment 1 | | | | | | | | | | | | |
| Comparative | PVDF-HFP | PVDF- | 0.002 | 0.002 | 9 | 9 | 4.72 | 96.12 | 86.23 | 91.01 | 5/10 | 0/10 |
| Embodiment 2 | | HFP | | | | | | | | | | |

As can be seen from Embodiments 1-1 to 1-17 and Comparative Embodiments 1 to 2, the electrode assembly of the secondary battery is a jelly-roll structure, the first separator and the second separator are used in combination, and the types of the first binder and the second binder are controlled within the range specified herein. The 1C discharge capacity retention rate of the lithium-ion battery is relatively high, the 2C discharge capacity retention rate of the battery is relatively high, and the 130° C. and 132° C. hot-oven test pass rates are relatively high, indicating that the lithium-ion battery of this application exhibits good cycle performance, C-rate performance, and safety performance. In Comparative Embodiment 1, the first binder is PI that melts at a relatively high melting point and can improve the thermal stability of the separator at high temperature. Therefore, the hot-oven test pass rate of the lithium-ion battery in Comparative Embodiment 1 is relatively high, and the safety performance of the lithium-ion battery is good. However, the swelling capacity of the PI is low under normal temperature conditions, and the PI is of relatively low adhesiveness and relatively low ionic conductivity, thereby resulting in relatively low C-rate performance and cycle performance of the lithium-ion battery. In Comparative Embodiment 2, the second binder is PVDF-HFP. The PVDF-HFP is well compatible with the electrolyte solution and is of relatively high adhesiveness to the electrode plate, and is of high ionic conductivity, thereby being conducive to lithium ion migration, and in turn, contributing to relatively high C-rate performance and cycle performance of the lithium-ion battery. However, the PVDF-HFP melts at a low melting point, and is of low thermal stability at high temperature. The hot-oven test pass rate of the lithium-ion battery is low, and the safety performance of the lithium-ion battery is inferior.

The structure of the electrode assembly typically affects the cycle performance and C-rate performance of the lithium-ion battery. As can be seen from Embodiments 1-1 and 1-14, when the structure of the electrode assembly falls within the range specified herein, the 1C discharge capacity retention rate of the lithium-ion battery is relatively high, the 2C discharge capacity retention rate of the battery is relatively high, the 1000th-cycle capacity retention rate is relatively high, and the 130° C. and 132° C. hot-oven test pass rates of the lithium-ion battery are relatively high, indicating that the lithium-ion battery of this application exhibits good cycle performance, C-rate performance, and safety performance.

The coating weight CW1 of the first bonding layer and the coating weight CW2 of the second bonding layer typically affect the cycle performance, C-rate performance, safety performance, and energy density of the lithium-ion battery. As can be seen from Embodiment 1-1 and Embodiments 1-5 to 1-9, when the coating weight CW1 of the first bonding layer and the coating weight CW2 of the second bonding layer fall within the range specified herein, the 1C discharge capacity retention rate of the lithium-ion battery is relatively high, the 2C discharge capacity retention rate is relatively high, the 1000th-cycle capacity retention rate is relatively high, and the 130° C. and 132° C. hot-oven test pass rates are relatively high, indicating that the lithium-ion battery of this application exhibits good cycle performance, C-rate performance and safety performance and possesses a relatively high energy density.

The average particle diameter D1 of the first binder and the average particle diameter D2 of the second binder typically affect the cycle performance, C-rate performance, and safety performance of the lithium-ion battery. As can be seen from Embodiment 1-1 and Embodiments 1-10 to 1-13, when the average particle diameter D1 of the first binder and the average particle diameter D2 of the second binder fall within the ranges specified herein, the 1C discharge capacity retention rate of the lithium-ion battery is relatively high, the 2C discharge capacity retention rate of the battery is relatively high, the 1000th-cycle capacity retention rate is relatively high, and the 130° C. and 132° C. hot-oven test pass rates of the battery are relatively high, indicating that the lithium-ion battery of this application exhibits good cycle performance and C-rate performance in addition to good safety performance.

The first separator further includes a first ceramic coating. The first ceramic coating includes first ceramic particles. The type of the first ceramic particles typically affects the safety performance of the lithium-ion battery. As can be seen from Embodiments 1-1 and 1-15, when the first separator further includes a first ceramic coating, the first ceramic coating includes first ceramic particles, and the type of the first ceramic particles falls within the range specified herein, the 1C discharge capacity retention rate of the lithium-ion battery is relatively high, the 2C discharge capacity retention rate is relatively high, the 1000th-cycle capacity retention rate is relatively high, and the 130° C. and 132° C. hot-oven test pass rates are relatively high, indicating that the lithium-ion battery of this application exhibits good safety performance in addition to good cycle performance and C-rate performance.

The second separator further includes a second ceramic coating. The second ceramic coating includes second ceramic particles. The type of the second ceramic particles typically affects the safety performance of the lithium-ion battery. As can be seen from Embodiments 1-1 and 1-16, when the second separator further includes a second ceramic coating, the second ceramic coating includes second ceramic particles, and the type of the second ceramic particles falls within the range specified herein, the 1C discharge capacity retention rate of the lithium-ion battery is relatively high, the 2C discharge capacity retention rate of the battery is relatively high, the 1000th-cycle capacity retention rate is relatively high, and the 130° C. and 132° C. hot-oven test pass rates are relatively high, indicating that the lithium-ion battery of this application exhibits good safety performance in addition to good cycle performance and C-rate performance.

The first separator further includes a first ceramic coating, and the first ceramic coating includes first ceramic particles. The second separator further includes a second ceramic coating, and the second ceramic coating includes second ceramic particles. The type of the first ceramic particles and the type of the second ceramic particles typically affect the safety performance of the lithium-ion battery. As can be seen from Embodiments 1-1 and 1-17, when the first separator further includes a first ceramic coating, the first ceramic coating includes first ceramic particles, the second separator further includes a second ceramic coating, the second ceramic coating includes second ceramic particles, and the type of the first ceramic particles and the type of the second ceramic particles fall within the ranges specified herein, the 1C discharge capacity retention rate of the lithium-ion battery is relatively high, the 2C discharge capacity retention rate is relatively high, the 1000th-cycle capacity retention rate is relatively high, and the 130° C. and 132° C. hot-oven test pass rates are relatively high, indicating that the lithium-ion battery of this application exhibits good safety performance in addition to good cycle performance and C-rate performance.

TABLE 2

| | | | | | | | 1 C | 2 C | 1000^{th}- | 130° C. | 132° C. |
|---|---|---|---|---|---|---|---|---|---|---|---|
| | | | | | | | discharge | discharge | cycle | hot-oven | hot-oven |
| | | | | | | | capacity | capacity | capacity | test | test |
| | | D3 | | D4 | D5 | D6 | retention | retention | retention | pass | pass |
| | Third binder | (nm) | Fourth binder | (nm) | (μm) | (μm) | rate (%) | rate (%) | rate (%) | rate | rate |
| Embodiment 1-1 | CMC | 140 | CMC | 140 | 20 | 20 | 95.12 | 85.34 | 86.25 | 10/10 | 8/10 |
| Embodiment 2-1 | Polyacrylic acid | 140 | Polyacrylic acid | 140 | 20 | 20 | 94.86 | 84.53 | 85.34 | 10/10 | 5/10 |
| Embodiment 2-2 | PVA | 140 | PVA | 140 | 20 | 20 | 93.21 | 83.12 | 84.23 | 10/10 | 2/10 |
| Embodiment 2-3 | CMC | 130 | CMC | 130 | 20 | 20 | 94.23 | 83.56 | 84.56 | 10/10 | 8/10 |
| Embodiment 2-4 | CMC | 150 | CMC | 150 | 20 | 20 | 94.56 | 83.89 | 84.68 | 10/10 | 8/10 |
| Embodiment 2-5 | CMC | 100 | CMC | 100 | 20 | 20 | 92.13 | 82.12 | 83.24 | 10/10 | 8/10 |
| Embodiment 2-6 | CMC | 200 | CMC | 200 | 20 | 20 | 92.5 | 82.6 | 83.89 | 10/10 | 8/10 |
| Embodiment 2-7 | CMC | 140 | CMC | 140 | 11 | 11 | 93.54 | 83.98 | 84.98 | 10/10 | 6/10 |
| Embodiment 2-8 | CMC | 140 | CMC | 140 | 24 | 24 | 93.23 | 83.65 | 88.00 | 10/10 | 7/10 |
| Embodiment 2-9 | CMC | 140 | CMC | 140 | 8 | 8 | 95.54 | 85.62 | 79.02 | 10/10 | 9/10 |
| Embodiment 2-10 | CMC | 140 | CMC | 140 | 27 | 27 | 89.98 | 80.89 | 85.85 | 10/10 | 9/10 |

The first negative electrode material layer includes a third binder, and the type and the average particle diameter D3 of the third binder affect the cycle life of the lithium-ion battery. As can be seen from Embodiment 1-1 and Embodiments 2-1 to 2-6, when the first negative electrode material layer includes a third binder, and the type and the average particle diameter D3 of the third binder fall within the ranges specified herein, the 1C discharge capacity retention rate of the lithium-ion battery is relatively high, the 2C discharge capacity retention rate of the battery is relatively high, the 1000th-cycle capacity retention rate is relatively high, and the 130° C. and 132° C. hot-oven test pass rates of the battery are relatively high, indicating that the lithium-ion battery of this application exhibits good cycle performance, C-rate performance and safety performance.

The second negative electrode material layer includes a fourth binder, and the type and the average particle diameter D4 of the fourth binder typically affect the cycle life of the lithium-ion battery. As can be seen from Embodiment 1-1 and Embodiments 2-1 to 2-6, when the second negative electrode material layer includes a fourth binder, and the type and the average particle diameter D4 of the fourth binder fall within the ranges specified herein, the 1C discharge capacity retention rate of the lithium-ion battery is relatively high, the 2C discharge capacity retention rate of the battery is relatively high, the 1000th-cycle capacity retention rate is relatively high, and the 130° C. and 132° C. hot-oven test pass rates of the battery are relatively high, indicating that the lithium-ion battery of this application exhibits good cycle performance, C-rate performance and safety performance.

The first negative electrode material layer includes a first negative active material, and the average particle diameter D5 of the first negative active material typically affects the cycle performance and C-rate performance of the lithium-ion battery. As can be seen from Embodiment 1-1 and Embodiments 2-7 to 2-10, when the first negative electrode material layer includes a first negative active material, and the average particle diameter D5 of the first negative active material falls within the range specified herein, the 1C discharge capacity retention rate of the lithium-ion battery is relatively high, the 2C discharge capacity retention rate of the battery is relatively high, the 1000th-cycle capacity retention rate is relatively high, and the 130° C. and 132° C. hot-oven test pass rates of the lithium-ion battery are relatively high, indicating that the lithium-ion battery of this application exhibits good cycle performance, C-rate performance and safety performance. The average particle diameter of the first negative active material and the average particle diameter of the second negative active material in Embodiment 2-9 are relatively small, so that the negative active materials are of relatively high activity and react parasitically with the electrolyte solution to cause relatively many side reactions, thereby resulting in inferior cycle performance of the lithium-ion battery. The average particle diameter of the first negative active material and the average particle diameter of the second negative active material in Embodiment 2-10 are relatively large, and the negative active materials offer relatively few active sites, thereby resulting in inferior C-rate performance of the lithium-ion battery.

The second negative electrode material layer includes a second negative active material, and the average particle diameter D6 of the second negative active material typically affects the cycle performance and C-rate performance of the lithium-ion battery. As can be seen from Embodiment 1-1 and Embodiments 2-7 to 2-10, when the second negative electrode material layer includes a second negative active material, and the average particle diameter D6 of the second negative active material falls within the range specified herein, the 1C discharge capacity retention rate of the lithium-ion battery is relatively high, the 2C discharge capacity retention rate of the battery is relatively high, the 1000th-cycle capacity retention rate is relatively high, and the 130° C. and 132° C. hot-oven test pass rates of the lithium-ion battery are relatively high, indicating that the lithium-ion battery of this application exhibits good cycle performance, C-rate performance and safety performance.

It is hereby noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. A secondary battery, comprising an electrode assembly, wherein the electrode assembly is a jelly-roll structure; the electrode assembly comprises a positive electrode plate, a negative electrode plate, a first separator, and a second separator; the negative electrode plate is located between the first separator and the second separator; the first separator comprises a first bonding layer; the second separator comprises a second bonding layer; the first bonding layer comprises a first binder, and the second bonding layer comprises a second binder;
the first binder comprises at least one of polyvinylidene fluoride or poly(vinylidene fluoride-co-hexafluoropropylene); and
the second binder comprises at least one of polyimide, polyvinyl alcohol, or sodium carboxymethyl cellulose.

2. The secondary battery according to claim 1, wherein the negative electrode plate comprises a negative current collector, a first negative electrode material layer, and a second negative electrode material layer; the first negative electrode material layer and the second negative electrode material layer are located on two sides of the negative current collector respectively; along a winding direction of the electrode assembly, a length of the first negative electrode material layer is greater than a length of the second negative electrode material layer; the first separator and the first negative electrode material layer are located on a first side of the negative electrode plate; and the second separator and the second negative electrode material layer are located on a second side of the negative electrode plate.

3. The secondary battery according to claim 1, wherein a coating weight of the first bonding layer is 0.0004 mg/mm² to 0.002 mg/mm², and a coating weight of the second bonding layer is 0.0004 mg/mm² to 0.002 mg/mm².

4. The secondary battery according to claim 1, wherein an average particle diameter of the first binder is 4 μm to 15 μm, and an average particle diameter of the second binder is 10 μm to 20 μm.

5. The secondary battery according to claim 2, wherein the first negative electrode material layer comprises a third binder; the third binder comprises at least one of polyvinylidene fluoride, carboxymethyl cellulose, polyacrylic acid, polyvinyl alcohol, or sodium alginate; and an average particle diameter of the third binder is 130 nm to 150 nm.

6. The secondary battery according to claim 2, wherein the second negative electrode material layer comprises a fourth binder; the fourth binder comprises at least one of polyvinylidene fluoride, carboxymethyl cellulose, polyacrylic acid, polyvinyl alcohol, or sodium alginate; and an average particle diameter of the fourth binder is 130 nm to 150 nm.

7. The secondary battery according to claim 2, wherein the first negative electrode material layer comprises a first negative active material, and an average particle diameter of the first negative active material is 11 μm to 24 μm.

8. The secondary battery according to claim 2, wherein the second negative electrode material layer comprises a second negative active material, and an average particle diameter of the second negative active material is 11 μm to 24 μm.

9. The secondary battery according to claim 1, wherein the first separator further comprises a first ceramic coating, and/or, the second separator further comprises a second ceramic coating; the first ceramic coating comprises a first ceramic particle, the second ceramic coating comprises a second ceramic particle, the first ceramic particle and the second ceramic particle each are at least one independently selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide.

10. The secondary battery according to claim 2, wherein the first separator further comprises a first ceramic coating, and/or, the second separator further comprises a second ceramic coating; the first ceramic coating comprises a first ceramic particle, the second ceramic coating comprises a second ceramic particle, the first ceramic particle and the second ceramic particle each are at least one independently selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide.

11. An electronic device, comprising the secondary battery according to claim 1.

12. The electronic device according to claim 11, wherein the negative electrode plate comprises a negative current collector, a first negative electrode material layer and a second negative electrode material layer; the first negative electrode material layer and the second negative electrode material layer are located on two sides of the negative current collector respectively; along a winding direction of the electrode assembly, a length of the first negative electrode material layer is greater than a length of the second negative electrode material layer; the first separator and the first negative electrode material layer are located on a first side of the negative electrode plate; and the second separator and the second negative electrode material layer are located on a second side of the negative electrode plate.

13. The electronic device according to claim 11, wherein a coating weight of the first bonding layer is 0.0004 mg/mm² to 0.002 mg/mm², and a coating weight of the second bonding layer is 0.0004 mg/mm² to 0.002 mg/mm².

14. The electronic device according to claim 11, wherein an average particle diameter of the first binder is 4 μm to 15 μm, and an average particle diameter of the second binder is 10 μm to 20 μm.

15. The electronic device according to claim 12, wherein the first negative electrode material layer comprises a third binder, the third binder comprises at least one of polyvinylidene fluoride, carboxymethyl cellulose, polyacrylic acid, polyvinyl alcohol, or sodium alginate, and an average particle diameter of the third binder is 130 nm to 150 nm.

16. The electronic device according to claim 12, wherein the second negative electrode material layer comprises a fourth binder, the fourth binder comprises at least one of polyvinylidene fluoride, carboxymethyl cellulose, polyacrylic acid, polyvinyl alcohol, or sodium alginate, and an average particle diameter of the fourth binder is 130 nm to 150 nm.

17. The electronic device according to claim 12, wherein the first negative electrode material layer comprises a first negative active material, and an average particle diameter of the first negative active material is 11 μm to 24 μm.

18. The electronic device according to claim 12, wherein the second negative electrode material layer comprises a second negative active material, and an average particle diameter of the second negative active material is 11 μm to 24 μm.

19. The electronic device according to claim 11, wherein the first separator further comprises a first ceramic coating, and/or, the second separator further comprises a second ceramic coating, the first ceramic coating comprises a first ceramic particle, the second ceramic coating comprises a second ceramic particle, the first ceramic particle and the second ceramic particle each are at least one independently selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide.

20. The electronic device according to claim 12, wherein the first separator further comprises a first ceramic coating, and/or, the second separator further comprises a second ceramic coating, the first ceramic coating comprises a first ceramic particle, the second ceramic coating comprises a second ceramic particle, the first ceramic particle and the second ceramic particle each are at least one independently selected from aluminum oxide, boehmite, silicon oxide, magnesium oxide, titanium oxide, tin oxide, calcium oxide, zirconium oxide, yttrium oxide, silicon carbide, aluminum hydroxide, magnesium hydroxide, or calcium hydroxide.
